(19) United States
(12) Patent Application Publication
(10) Pub. No.: US 2019/0228339 A1
(43) Pub. Date: Jul. 25, 2019

(54) ELECTRONIC APPARATUS, METHOD AND SYSTEM FOR PROVIDING CONTENT INFORMATION, AND COMPUTER READABLE MEDIUM

(71) Applicant: Samsung Electronics Co., Ltd., Suwon-si (KR)

(72) Inventors: Kwanghyuk KIM, Suwon-si (KR); Hyunduk KIM, Suwon-si (KR)

(21) Appl. No.: 16/254,952

(22) Filed: Jan. 23, 2019

(30) Foreign Application Priority Data
Jan. 23, 2018 (KR) 10-2018-0008445

(51) Int. Cl. G06N 20/00; G06N 5/04; G06F 16/907

(52) U.S. Cl. CPC G06N 20/00; G06F 16/907; G06N 5/048

(57) ABSTRACT

The disclosure relates to an application of an artificial intelligence (AI) system utilizing a machine learning algorithm. An electronic apparatus is provided. The electronic apparatus includes: a display; a storage storing a content and metadata for the content therein; and a processor configured to control the display to display information indicating a degree to which an artificial intelligence model contributes to generation of the content based on the metadata.

### CROSS-REFERENCE TO RELATED APPLICATION

This application is based on and claims priority under 35 U.S.C. § 119 to Korean Patent Application No. 10-2018-0008445, filed on Jan. 23, 2018, in the Korean Intellectual Property Office, the disclosure of which is incorporated by reference herein in its entirety.

### BACKGROUND

### Field

The disclosure relates to an electronic apparatus, and, for example, to a technique for providing a user with information on contribution of an artificial intelligence model to content production, work content, and the like.

### Description of Related Art

An artificial intelligence system may refer, for example, to a computer system that implements human-level intelligence and is a system in which a recognition rate is improved as a machine learns, determines, and uses itself.

Artificial intelligence technology includes a machine learning (deep learning) technology using an algorithm that classifies/learns characteristics of input data itself, and elementary technologies that copies functions such as recognition, determination, and the like of human brain utilizing a machine learning algorithm.

Meanwhile, as the artificial intelligence technology is developed, an artificial intelligence model may now produce content themselves beyond simple suggestions or command execution.

However, conventionally, development of a method or UI technology for providing information on the content produced by the artificial intelligence model has been insufficient.

### SUMMARY

Embodiments of the disclosure address the above disadvantages and other disadvantages not described above.

Information on content may refer, for example, to information about who an artist is and what inspired it.

In addition, the information on the content is an important factor for people who touch the content because it is a measure of a value of the content as an artwork as well as clarifying the subject of the copyright.

The disclosure visually provides a user who browses specific content with information such as contribution of each artificial intelligence model participating in production of the content and work content.

According to an embodiment of the disclosure, an electronic apparatus includes: a display; a storage configured to store a content and metadata for the content therein; and a processor configured to control the display to display information indicating the degree to which an artificial intelligence model contributes to a generation of the content based on the metadata.

The metadata may include information on at least one of a name of the artificial intelligence model used to generate the content, a learning object used in learning of the artificial intelligence model, the degree to which the artificial intelligence model contributes to the generation of the content, or work content that the artificial intelligence model performs to generate the content.

When a plurality of artificial intelligence models are used to generate the content, the processor may control the display to display information indicating the degree to which each artificial intelligence model contributes to the generation of the content based on the metadata.

The processor may obtain the degree to which each of the plurality of artificial intelligence models contribute to the generation of the content based on at least one of a work time and/or an amount of work for each of the plurality of artificial intelligence models generating the content, and update the metadata based on the obtained degree of contribution.

The processor may control the display to display information on a learning object used in learning of the artificial intelligence model based on the metadata.

When learning objects having different characteristics are used in the learning of the artificial intelligence model, the processor may control the display to display information on the learning objects having different characteristics based on the metadata.

The processor may control the display to display the information on the learning objects having different characteristics and information indicating the degree of contribution in a hierarchy structure.

When a plurality of works are required to generate the content, the processor may control the display to display the information on the work content that the artificial intelligence model performs to generate the content based on the metadata.

According to another embodiment of the disclosure, a method for providing content information includes: obtaining the degree to which an artificial intelligence model contributes to generate the content based on metadata stored in a storage; and displaying, on a display, information indicating the degree to which the artificial intelligence model contributes to the generation of the content.

The metadata may include information on at least one of a name of the artificial intelligence model used to generate the content, a learning object used in learning of the artificial intelligence model, the degree to which the artificial intelligence model contributes to the generation of the content, and/or work content that the artificial intelligence model performs to generate the content.

In the displaying of the information, when a plurality of artificial intelligence models are used to generate the content, information indicating the degree to which each artificial intelligence model contributes to the generation of the content may be displayed on the display based on the metadata.

The method may further include: obtaining the degree to which each of the plurality of artificial intelligence models contribute to the generation of the content based on at least one of a work time and/or an amount of work of each of the plurality of artificial intelligence models for generating the content; and updating the metadata based on the obtained degree of contribution.

In the displaying of the information, information on a learning object used in learning of the artificial intelligence model may be displayed on the display based on the metadata.

In the displaying of the information, when learning objects having different characteristics are used in the learning of the artificial intelligence model, information on the learning objects having different characteristics may be displayed on the display based on the metadata.

In the displaying of the information, the information on the learning objects having different characteristics and information indicating the degree of contribution may be displayed on the display in a hierarchy structure.

In the displaying of the information, when a plurality of works are required to generate the content, the information on the work content that the artificial intelligence model performs to generate the content may be displayed on the display based on the metadata.

According to still another embodiment of the disclosure, a system for providing content information includes: an electronic apparatus configured to generate metadata for the content based on a result that each of one or more artificial intelligence models works to generate the content, and transmit the metadata; and a terminal apparatus configured to display, on a display, information indicating the degree to which one or more artificial intelligence models contribute to the generation of the content based on the metadata transmitted from the electronic apparatus.

According to still another embodiment of the disclosure, a non-transitory computer-readable recording medium having computer instructions stored thereon that are executed by a processor of an electronic apparatus to cause the electronic apparatus to perform operations, wherein the operations include: obtaining the degree to which an artificial intelligence model contributes to generate the content based on metadata stored in a storage; and displaying, on a display, information indicating the degree to which the artificial intelligence model contributes to the generation of the content.

According to various example embodiments of the disclosure as described above, it is possible to visually provide the user with the information on what artificial intelligence model participates in the content creation and the extent to which the artificial intelligence model has contributed to the content creation.

### BRIEF DESCRIPTION OF THE DRAWINGS

The above and/or other aspects, features and advantages of certain embodiments of the disclosure will be more apparent from the following detailed description, taken in conjunction with the accompanying drawings, in which:

FIG. 1 is a diagram illustrating an example of information to be provided to a user according to an embodiment of the disclosure;

FIG. 2 is a block diagram illustrating an example configuration of an electronic apparatus according to an embodiment of the disclosure;

FIG. 3 is a diagram illustrating an example embodiment according to the disclosure;

FIG. 4A is a diagram illustrating an example embodiment according to the disclosure;

FIG. 4B is a diagram illustrating an example embodiment according to the disclosure;

FIG. 5 is a diagram illustrating an example embodiment according to the disclosure;

FIG. 6 is a block diagram illustrating an example configuration of an electronic apparatus according to various example embodiments of the disclosure;

FIG. 7 is a flowchart illustrating an example method for providing content information according to an embodiment of the disclosure; and

FIG. 8 is a diagram illustrating an example system for providing content information according to an embodiment of the disclosure.

### DETAILED DESCRIPTION

Before describing the disclosure in detail, a method of describing the disclosure and drawings will be provided.

As terms used in the disclosure and claims, general terms have been selected by considering functions in various example embodiments of the disclosure. However, such terms may be varied depending on an intention of those skilled in the art, a legal or technical interpretation, an emergence of a new technology, and the like. Further, some terms may be terms which are arbitrarily selected. Such terms may be interpreted based on descriptions in the disclosure, and may also be interpreted based on general content of the disclosure and a typical technical concept in the art unless the terms are not specifically defined.

Further, the same reference numerals or symbols described in the accompanying drawings of the disclosure denote parts or components that perform substantially the same function. For convenience of explanation and understanding, the description will be provided using the same reference numerals or symbols in different embodiments. For example, although a plurality of drawings illustrate all of the components having the same reference numeral, the plurality of drawings are not limited to any one embodiment.

In addition, in order to distinguish between the components, terms including an ordinal number such as “first”, “second”, etc. may be used in the disclosure and claims. The ordinal number is used to distinguish the same or similar components from each other, and the meaning of the terms should not be interpreted as being limited due to the usage of the above-mentioned ordinal number. As an example, the components coupled to the ordinal number should not be interpreted as a use order, a layout order, or the like being limited by the number. The respective ordinal numbers are interchangeably used, if necessary.

In the disclosure, the singular expression includes the plural expression unless the context clearly indicates otherwise. In the application, the terms “include” or “consist of” intend to designate the presence of features, numbers, steps, operations, components, elements, or a combination thereof that are written in the disclosure, but do not exclude the presence or possibility of addition of one or more other features, numbers, steps, operations, components, elements, or a combination thereof.

A term “module”, “unit” “part”, or the like, in the embodiment of the disclosure is a term that may refer, for example, to the component performing at least one function or operation, and such component may be implemented in hardware or software or any combination of hardware and software. In addition, a plurality of “modules”, “units”, “parts”, or the like may be integrated into at least one module or chip and may be implemented in at least one processor, except for a case in which they need to be each implemented in individual specific hardware.

In addition, in example embodiments of the disclosure, it will be understood that when an element is referred to as being “connected to” another element, it can be directly “connected to” the other element or other elements intervening therebetween may be present. In addition, unless explicitly described otherwise, “comprising” any components will be understood to imply the inclusion of other components but not the exclusion of any other components.

In the disclosure, ‘at least one of a, b or c’ may refer, for example, to ‘only a, only b, only c, both a and b, both a and c, both b and c, all of a, b, and c, or variations thereof’.

Hereinafter, the disclosure will be described in greater detail with reference to the accompanying drawings.

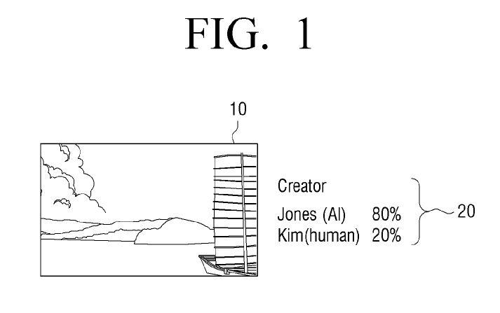

FIG. 1 is a diagram illustrating an example of information to be provided to a user according to an embodiment of the disclosure.

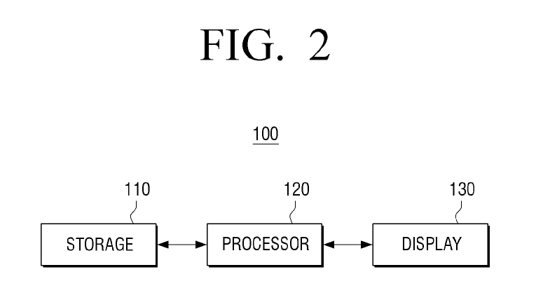

FIG. 1 illustrates a painting 10 and information 20 on the painting 10. As an example according to the disclosure, the painting 10 and the information 20 on the painting 10 which are included in FIG. 1 may be displayed on a display 130 (FIG. 2) of an electronic apparatus 100 (FIG. 2).

Referring to the information 20 of FIG. 1, it may be confirmed that subjects that draw the painting 10 are an artificial intelligence model “Jones” and human “Kim”, and contribution to the production of the painting 10 is 80 percent for “Jones” and 20 percent for “Kim”.

As described above, a user of the electronic apparatus 100 according to the disclosure may be provided with information about who produced specific content such as the painting 10 and the degree of the contribution of each producer through the display 130.

Hereinafter, detailed configurations and operations of the electronic apparatus 100 for providing content information will be described with reference to various figures.

FIG. 2 is a block diagram illustrating an example configuration of an electronic apparatus 100 according to an embodiment of the disclosure. Referring to FIG. 2, the electronic apparatus 100 may include a storage 110, a processor (e.g., including processing circuitry) 120, and a display 130.

The electronic apparatus 100 may be implemented, for example, and without limitation, as a television (TV), a server, a set-top box, a personal computer (PC), a portable phone, or the like.

The storage 110 may store an operating system (OS) for controlling an overall operation of the components of the electronic apparatus 100, and commands or data associated with the components of the electronic device 100.

The storage 110 may be implemented, for example, and without limitation, as a non-volatile memory (e.g., a hard disk, a solid state drive (SSD), a flash memory, or the like), a volatile memory, or the like.

The storage 110 may store one or more contents and metadata for each of one or more contents.

The content may refer, for example, to a concept that includes all kinds of creations or imitations such as, for example, and without limitation, paintings, photographs, movies, music, poems, novels, cartoons, games, and the like.

In addition, the metadata for the content may include information on, for example, and without limitation, at least one of a name of an artificial intelligence model used to generate the content, a learning object used in learning of the artificial intelligence model, the degree to which the artificial intelligence model contributes to the generation of the content, work content that the artificial intelligence model performs to generate the content, or the like.

For example, in case that an artificial intelligence model “Lee” creates a content “Z”, the metadata may include a name “Lee” of the artificial intelligence model that generates the content “Z”.

A more detailed example of information that may be included in the metadata will be provided together with a description of various embodiments according to the disclosure.

The processor 120 may include various processing circuitry and controls an overall operation of the electronic apparatus 100.

The processor 120 may include a random access memory (RAM) (not illustrated), a read only memory (ROM) (not illustrated), a central processing unit (CPU) (not illustrated), a graphic processing unit (GPU) (not illustrated), a system bus (not illustrated), and the like, and may execute operations or data processing relating to control of other components included in the electronic apparatus 100.

The display 130 may be implemented, for example, and without limitation, as a liquid crystal display (LCD), a plasma display panel (PDP), an organic light emitting diodes (OLED), a transparent OLED (TOLED), or the like to display information on the content under the control of the processor 120. In case that the display 130 is implemented as the LCD, the display 130 may include various circuitry including, for example, and without limitation, a driving circuit, a backlight unit, and the like which may be implemented in the form of, for example, and without limitation, an a-si TFT, a low temperature poly silicon (LTPS) TFT, an organic TFT (OTFT), and the like.

The display 130 may also be implemented in the form of a touch screen capable of detecting a touch manipulation of a user.

According to an embodiment of the disclosure, the processor 120 may control the display to display the information indicating the degree to which the artificial intelligence model contributes to the generation of the content based on the metadata for the content on the display 130.

The degree of contribution may, for example, be based on the degree to which the artificial intelligence model participates in the entire process of content production. As an example, in case that the artificial intelligence model directly performs half of the process of the content production, the degree to which the artificial intelligence model contributes to the generation of content may be 50 percent.

If a plurality of artificial intelligence models are used to generate the content, the processor 120 may control the display 130 to display information indicating the degree to which each artificial intelligence model contributes to the generation of the content based on the metadata.

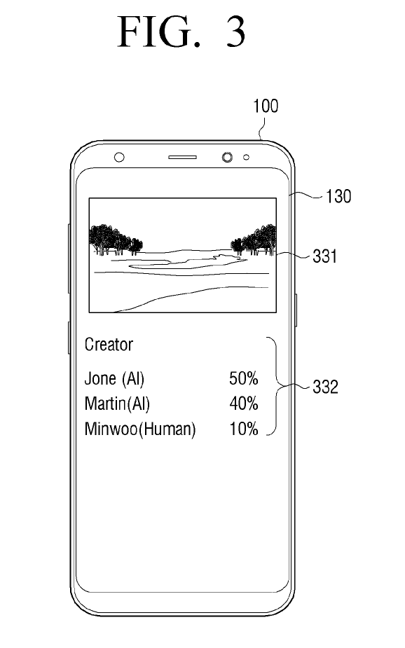

FIG. 3 is a diagram illustrating an example that content information is displayed on the display 130 of the electronic apparatus 100 according to the disclosure. In FIG. 3, it is assumed that artificial models “Jone” and “Martin”, and a human “Minwoo” participate in a production process of a painting 331 corresponding to the content.

If the degree to which “Jone” contributes to the production of the painting 331 is 50 percent, the degree to which Martin contributes thereto is 40 percent, and the degree to which “Minwoo” contributes thereto is 10 percent, the processor 120 may control the display to display information 332 on the painting 331 as illustrated in FIG. 3. This may be in accordance with a user command requesting the painting 331 and the information on the painting 331.

For example, the information 332 on the painting 331 may include the degrees to which “Jone”, “Martin”, and “Minwoo” contribute to the production of the painting 331, respectively.

When the user touches any one of “Jone”, “Martin”, and “Minwoo”, which may, for example, be texts displayed on the display 130 implemented as the touchscreen, the information 332 on the painting 331 may also be provided in the form of a user interface (UI) to which additional information for a touched object is provided.

The processor 120 may obtain the degree to which each of the plurality of artificial intelligence models contributes to the generation of the content based on at least one of a working time and a work amount of each of the plurality of artificial intelligence models for generating the content.

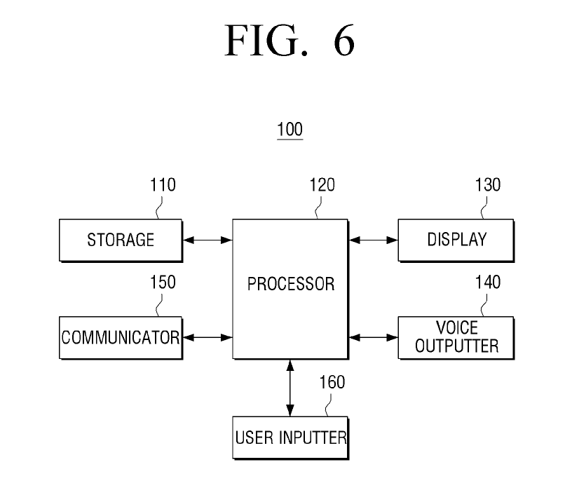

The processor 120 may receive information on the work of each of the plurality of artificial intelligence models from an external device (not illustrated) through which the content is produced through the communicator (e.g., including communication circuitry) 150 (FIG. 6).

In an example embodiment in which the electronic apparatus 100 includes the artificial intelligence model for producing content and/or includes an application for content production and the production of the content is performed in the electronic apparatus 100, the processor 120 may cause the electronic apparatus 100 to store the information on the work of each of the plurality of artificial intelligence models in the storage 110.

The information on the work may, for example, and without limitation, include information on a status change of the content before and after the work, the time taken for the work, and the subject of the work.

For example, if the total time taken for the production process of the painting 331 is 10 hours and (assuming that there was no time for “Jone”, “Martin”, and “Minwoo” simultaneously participating in the production), “Jone” works for 5 hours, “Martin” works for 4 hours, and “Minwoo” works for 1 hour during 10 hours, the processor 120 may obtain the degree of contribution as 50 percent for “Jone”, 40 percent for “Martin”, and 10 percent for “Minwoo”, respectively.

The processor 120 may obtain the degree to which “Jone”, “Martine”, and “Minwoo” contribute to the production of the painting 331 based on an amount of work that each of “Jone”, “Martine”, and “Minwoo” works.

The amount of work may be determined based on the amount of data change in the painting 331 before and after each of Jone, Martin, and Minwoo works.

In an example in which “Jone”, “Martine”, and “Minwoo” divide the section of the painting 331 into three sections and each of “Jone”, “Martine”, and “Minwoo” takes draws one section, the amount of work may also be determined by the processor 120 or the external apparatus based on a ratio that the section that each of “Jone”, “Martine”, and “Minwoo” takes occupies in an overall size of the painting.

The processor 120 may update the metadata based on the obtained degree of contribution. For example, the processor may control the display to display the information indicating the degree to which each artificial intelligence model contributes to the generation of the content on the display 130, based on the updated metadata.

The processor 120 may be authenticated by the plurality of artificial intelligence models or the users of the plurality of artificial intelligence models, respectively, for the degree to which the plurality of artificial intelligence models contributed to the generation of the content.

This is to determine the degree of contribution, with the consent of artists including the plurality of artificial intelligence models participating in the content production.

As a method of the authentication, the user of each of the plurality of artificial intelligence models may confirm that the obtained degree of contribution is displayed on the display 130 and then sign the display 130 implemented as the touchscreen.

Each of the plurality of artificial intelligence models may compare a completed content with its own work content to determine the degree of contribution of itself, and then determine whether a difference from the degree of contribution obtained by the processor 120 is less than a predetermined value.

When the obtained degree of contribution is authenticated, the processor 120 may update the metadata based on the obtained degree of contribution, and may display, on the display 130, the information indicating the degree to which each artificial intelligence model contributes to the generation of the content based on the updated metadata.

The processor 120 may control the display 130 to display information on a learning object used for learning of the artificial intelligence model based on the metadata.

The learning object may refer, for example, to whether the artificial intelligence model performs the learning based on the work of a person (or artificial intelligence) in acquiring the technique used to generate the content.

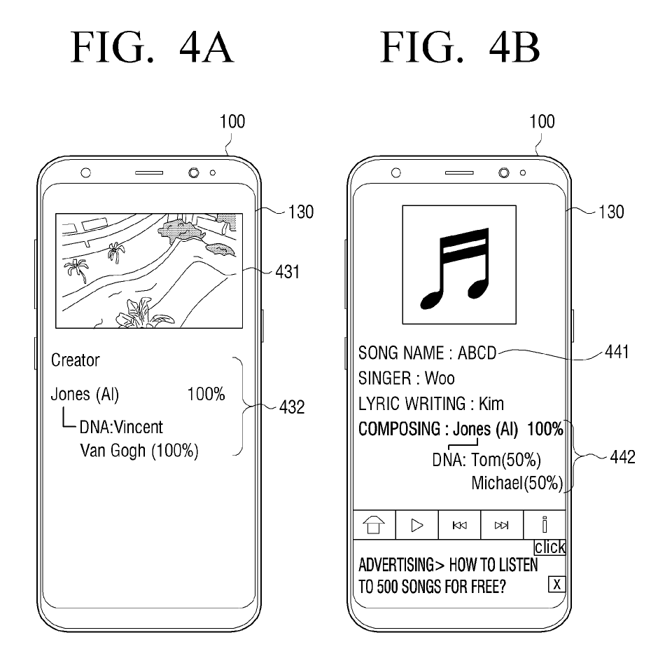

FIG. 4A is a diagram illustrating an example in which the processor 120 controls the display 130 to display the information on the learning object used for learning of the artificial intelligence model generating the content.

FIG. 4A assumes a situation in which the processor 120 controls the display 130 to display information 432 on a painting 431 together with the painting 431 based on a user command requesting the painting 431 and the information 432 on the painting 431.

The information 432 on the painting 431 includes the name of the artificial intelligence model “Jones” that produces the painting 431, and the degree (100 percent) to which “Jones” contributes. In addition, the information 432 on the painting 431 includes information that a DNA of “Jones” was 100 percent attributed to “Vincent Van Gogh”.

Through this, the user may recognize that the artificial intelligence model “Jones”, which learns only works drawn by “Vincent Van Gogh”, has performed the entire process the production of the painting 431.

In this case, when the user touches any one of “Jones” and “Vincent Van Gogh”, which may, for example, be texts displayed on the display 130 implemented as the touchscreen, the information 432 on the painting 431 may also be provided in the form of a user interface (UI) to which additional information for a touched object is provided.

In an example embodiment in which learning objects with different characteristics are used in the learning of the artificial intelligence model, the processor 120 may control the display to display information on the learning objects having difference characteristics based on the metadata.

FIG. 4B is a diagram illustrating an example in which the information on the learning objects having different characteristics are displayed on the display 130 based on the metadata.

FIG. 4B assumes a case in which a song “ABCD” 441 was composed only by an artificial intelligence model “Jones”, and “Jones” is an artificial intelligence model which learns only songs composed by humans “Tom” and “Michael”.

In this case, the processor 120 may control the display 130 to display information on “ABCD” including composer information 442 of “ABCD” as illustrated in FIG. 4B based on a user command requesting information on “ABCD” 441, and the composer information 442 of “ABCD” may include a name of the artificial intelligence model “Jones” that learns the songs composed by the different persons “Tom” and “Michael” in a ratio of 50:50.

In addition, the processor 120 may also control the display 130 to display information on the learning objects having different characteristics and information indicating the degree of contribution in a hierarchy structure.

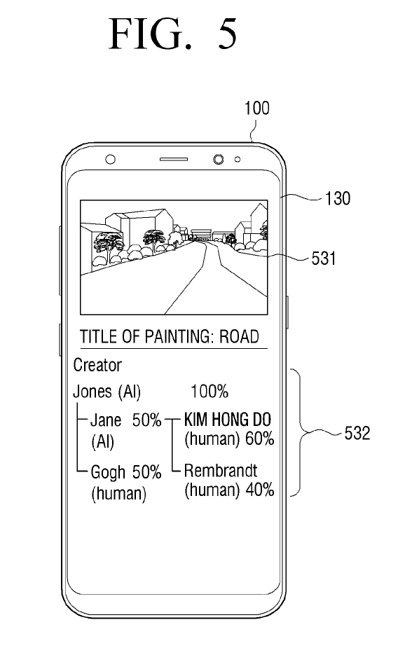

FIG. 5 is a diagram illustrating an example in which the processor 120 controls the display 130 to display a painting 531 and information 532 on the painting 531 based on a user command requesting the painting 531 and the information on the painting 531.

Referring to FIG. 5, the information 532 on the painting 531 includes a name of a creator “Jones” and the degree of contribution, the names of “Jane” (AI) and “Gogh”, which are the learning objects of “Jones”, and a learning ratio, and the names of “Kim Hong Do” and “Rembrandt”, which are the learning objects of “Jane” (AI), and a leaning ratio.

In addition, referring to FIG. 5, the processor 120 may control the display 130 to display the information 532 in a hierarchical structure to suit a learning relationship in displaying information 532 on the painting 531 on display 130. For example, “Jones” is connected to “Jane” and “Gogh”, which are the learning objects, and “Jane” is again connected to “Kim Hong Do” and “Rembrandt”, which are the learning objects.

In an example embodiment in which a plurality of works are required to generate the content, the processor 120 may control the display 130 to display information on the work content performed by the artificial intelligence model to generate the content based on the metadata.

Examples of the plurality of works for generating the content may include a plurality of works such as, for example, and without limitation, composing, lyric writing, and singing in producing a song, or the like, and a plurality of works such as, for example, and without limitation, object selection, sketching, coloring in producing a painting, or the like.

Referring again to FIG. 4B, because the production of the song “ABCD” requires a plurality of works such as composing, lyric writing, and singing, the processor 120 may confirm that information including all names of a singer (“Woo”) singing “ABCD”, a lyric writer (“Kim”) of “ABCD”, and a composer (“Jones”) of “ABCD” may be displayed on the display 130.

For example, the processor 120 may control the display 130 to display information including a fact that the content worked by the artificial intelligence model “Jones” is the composition in producing “ABCD”.

FIG. 6 is a block diagram illustrating an example configuration of the electronic apparatus 100 according to various example embodiments of the disclosure.

Referring to FIG. 6, the electronic apparatus 100 may include the storage 110, the processor (e.g., including processing circuitry) 120, the display 130, a voice outputter (e.g., including voice output circuitry) 140, a communicator (e.g., including communication circuitry) 150, a user inputter (e.g., including input circuitry) 160, and the like.

The voice outputter 140 may include various voice output circuitry for outputting audio corresponding to a specific content under the control of the processor 120, and may output, for example, and without limitation, audio corresponding to information on a content included in a broadcasting signal received through a tuner (not illustrated), information on the content included in the received broadcasting signal, information on a content input through the communicator 150, content input via a microphone (not illustrated), information on a content stored in the storage 110, or the like.

In addition, the voice outputter may also include various circuitry including, for example, and without limitation, a speaker (not illustrated), a headphone/earphone output terminal (not illustrated), or the like.

In this regard, the processor 120 may also output audio corresponding to the information indicating the degree to which the artificial intelligence model contributes to the generation of the content through the voice outputter 140.

The communicator 150 may include various communication circuitry for performing data communication with an external apparatus (not illustrated) in a wireless or wired manner, and the processor 120 may perform communication with a variety of external devices using the communicator 150.

In case that the data communication with the external apparatus is performed by a wireless communication manner, the communicator 150 may include various communication circuitry included in various communication modules, such as, for example, and without limitation, at least one of WIFIDIRECT communication module, a Bluetooth module, an infrared data association (IrDA) module, a near field communication (NFC) module, a Zigbee module, a cellular communication module, a third-generation (3G) mobile communication module, a fourth-generation (4G) mobile communication module, a long term evolution (LTE) communication module, or the like.

In an example embodiment in which the data communication with the external apparatus is performed in a wired communication manner, the communicator 150 may include various communication circuity to provide an interface module such as, for example, and without limitation, USB, or the like, and may be physically connected to an external terminal device such as, for example, and without limitation, a PC, or the like, through the interface module to transmit and receive image data, or transmit and receive firmware data for performing firmware update.

As an example, the processor 120 of the electronic apparatus 100, which is a server, may control the communicator 150 to receive information on the work of the artificial intelligence model from an external apparatus (not illustrated) including the artificial intelligence model and in which the content production by the artificial intelligence model is performed.

The processor 120 may establish metadata for the content based on the received information on the work, and may display on the display 130 the information indicating the degree to which the artificial intelligence model contributes to the generation of the content based on the metadata.

The user inputter 160 may include various input circuitry that receives various user commands. The processor 120 may execute a function corresponding to the user command input through the user inputter 160.

For example, the user inputter 160 may receive a user command requesting a specific content and information on the corresponding content, and the processor 120 may control the display 130 to display information on the corresponding content based on the received user command.

The user inputter 160 may include various circuitry including, for example, and without limitation, a microphone (not illustrated) to receive the user command in the form of voice, the display 130 as a touchscreen, a separate touch pad (not illustrated) to receive the user command as a touch, or the like.

In addition, the user inputter 160 may also receive a signal including the user command from a remote controller (not illustrated) for controlling the electronic apparatus 100.

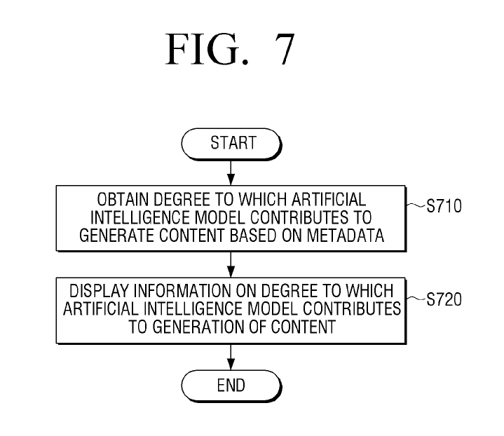

FIG. 7 is a flowchart illustrating an example method for providing content information of an electronic apparatus according to an embodiment of the disclosure.

The processor 120 may obtain the degree to which an artificial intelligence model contributes to generation of content based on metadata stored in the storage 110 (S710).

The metadata may include information on at least one of a name of the artificial intelligence model used for generation of the content, a learning object used for learning of the artificial intelligence model, the degree to which the artificial intelligence model contributes to the generation of the content, and/or a work content that the artificial intelligence model performs to generate the content.

In addition, the processor 120 may control the display 130 to display information indicating the degree to which the artificial intelligence module contributes to the generation of the content (S720).

As an example, in an example embodiment in which a specific content is completed by a work of only an artificial intelligence model “Betago”, the processor 120 may control the display 130 to display a name of “Betago” and the degree (100 percent) of contribution together with the corresponding content.

If a plurality of artificial intelligence models are used to generate the content, the processor 120 may control the display 130 to display information indicating the degree to which each artificial intelligence model contributes to the generation of the content based on the metadata.

For example, if two artificial intelligence models create a specific novel by half of the specific novel, respectively, the processor 120 may control the display 130 to display names of the two artificial intelligence models and the degree (50 percent, respectively) of contribution.

The processor 120 may obtain the degree to which each of the plurality of artificial intelligence models contributes to the generation of the content based, for example, and without limitation, on at least one of a work time and an amount of work of each of the plurality of artificial intelligence models for generating the content, or the like, and may also update the metadata based on the obtained degree of contribution.

As an example, it may be assumed that a content “A” is newly produced based on artificial intelligence models “alpha” and “beta” in a state in which no information on the content “A” is present in the existing metadata.

In an example embodiment in which “alpha” works for 4 hours and “beta” works for 1 hour in production of content “A” assuming that “alpha” and “beta” have the same work intensity per unit time, the processor 120 may obtain that the degree of contribution of “alpha” is 80 percent and the degree of contribution of “beta” is 20 percent based on the work time, and may update the metadata stored in the storage 110 based on the degree of contribution.

For example, the processor 120 may add the name of “alpha” and the degree (80 percent) of contribution thereof, the name of “beta” and the degree (20 percent) of contribution thereof, and information on the content “A” to the existing metadata.

The processor 120 may update the metadata so that the names of “alpha” and “beta” and the degree of contribution thereof are included in or matched to the information on the content “A”.

The processor 120 may control the display 130 to display information on a learning object used for learning of the artificial intelligence model based on the metadata.

For example, the learning object may refer, for example, to whether the artificial intelligence model performs the learning based on the work of a person (or artificial intelligence) in acquiring the technique used to produce the content.

In an example embodiment in which learning objects having different characteristics are used in learning of the artificial intelligence model, the processor 120 may also control the display 130 to display information on the learning objects having different characteristics based on the metadata.

This takes into account the fact that the learning of the artificial intelligence model is generally based on the work of a plurality of objects rather than a single object. Based on various experience based on the work of the plurality of objects, the artificial intelligence model may establish (generate/classify data) and manage (utilize data) knowledge.

The processor 120 may also control the display 130 to display information on the learning objects having different characteristics and information indicating the degree of contribution in a hierarchy structure.

Accordingly, when a specific artificial intelligence model learns from another artificial intelligence model, because information about who is learned by another artificial intelligence model may be provided to the user at the same time together with information on another artificial intelligence model, all objects that have influenced the work of the specific artificial intelligence model may be confirmed.

In an example embodiment in which a plurality of works are required to generate the content, the processor 120 may also control the display 130 to display information on the work content performed by the artificial intelligence model to generate the content based on the metadata.

For example, when a plurality of artificial intelligence models and persons divide and work a plurality of works such as composing scenarios for making novels, configuring individual sentences, and checking spelling, the processor 120 may control the display 130 to display information on who performed each work.

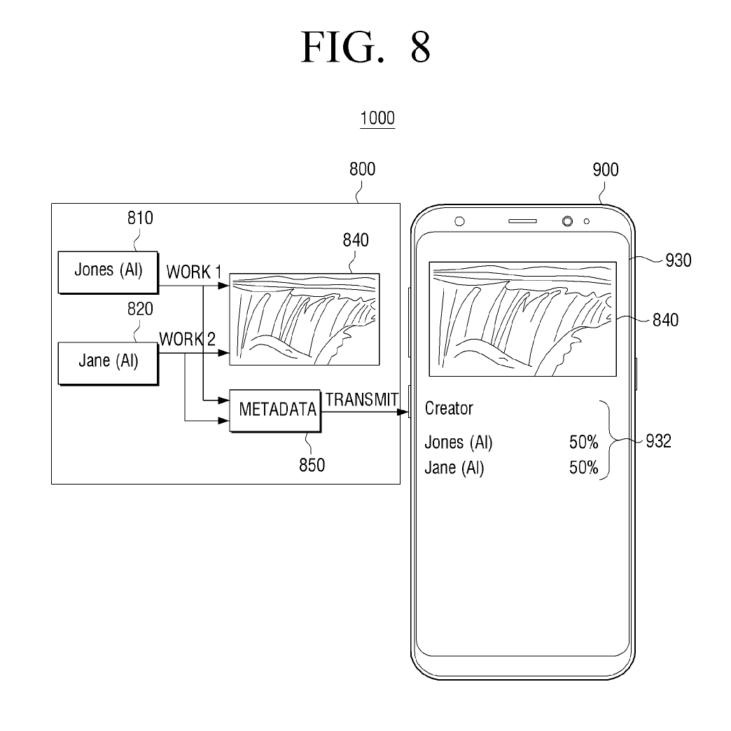

FIG. 8 is a diagram illustrating an example system 1000 for providing content information according to an embodiment of the disclosure.

Referring to FIG. 8, a system 1000 may include an electronic apparatus 800 and a terminal apparatus 900. FIG. 8 includes a block diagram of the electronic apparatus 800 for describing a content generation work and a metadata generation process which are performed in the electronic apparatus 800, and a diagram of the terminal apparatus 900 providing information on the content based on the metadata.

The electronic apparatus 800 may be implemented, for example, and without limitation, as a computer including one or more artificial intelligence models, or the like, or may be implemented, for example, and without limitation, as a server, or the like.

The electronic apparatus 800 may generate the metadata for the content based on a result that each of the one or more artificial intelligence models works to generate the content, and may transmit the generated metadata.

The metadata may include information on at least one of, for example, and without limitation, a name of the artificial intelligence model used for generation of the content, a learning object used for learning of the artificial intelligence model, the degree to which the artificial intelligence model contributes to the generation of the content, a work content that the artificial intelligence model performs to generate the content, or the like.

FIG. 8 assumes an example in which the electronic apparatus 800 includes two artificial intelligence models “Jones” 810 and “Jane” 820. In order to include the two artificial intelligence models as illustrated in FIG. 8, the electronic apparatus 800 may also be implemented as a system including a plurality of electronic apparatuses rather than one electronic apparatus, but the disclosure is not limited thereto.

The electronic apparatus 800 may generate metadata 850 including information on a painting 840 based on a work 1 of “Jones” 810 and a work 2 of “Jane” 820 for generating the painting 840.

The metadata 850 of FIG. 8 may include information on the names of the artificial intelligence models “Jones” and “Jane” used to generate the painting 840, and the degree (50 percent, respectively) to which “Jones” and “Jane” contribute to the generation of the painting 840.

Unlike the example illustrated in FIG. 8, the electronic apparatus 800 may also obtain the metadata 850 by receiving the results that “Jones” 810 and “Jane” 820 work from an external apparatus (not illustrated) including the artificial intelligence models “Jones” 810 and “Jane” 820.

The terminal apparatus 900 may be implemented, for example, and without limitation, as a portable phone, or the like, and may also be implemented, for example, and without limitation, as a PC, a TV, or the like, that transmits and receives information from a specific server.

The terminal apparatus 900 may display on a display 930 of the terminal apparatus 900 information indicating the degree to which one or more artificial intelligence models contribute to the generation of the content based on the metadata transmitted from the electronic apparatus 800.

As an example, referring to FIG. 8, it may be seen that the terminal apparatus 900 displays on the display 930 information 932 including the degree (50 percent, respectively) to which the artificial intelligence models “Jones” 810 and “Jane” 820 contribute to generate the painting 840 together with the painting 840 based on the metadata 850.

According to various example embodiments described above, the electronic apparatus 100 and/or the system 1000 for providing the content information may effectively provide contribution information of the artificial intelligence model participating in generating of the specific content to the user.

The various example embodiments described above may be implemented in a recording medium that is readable by a computer and/or a device similar to the computer using software, hardware, or any combination thereof.

With hardware implementation, the example embodiments described in the disclosure may be implemented using, for example, and without limitation, at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units (e.g., circuits), or the like, for performing other functions.

Various example embodiments described in the disclosure may be implemented as the processor 120 itself. With software implementation, embodiments such as procedures and functions described in the disclosure may be implemented as separate software modules. Each of the software modules described above may perform one or more functions and operations described in the specification.

Computer instructions for performing processing operations in the electronic apparatus 100 according to various example embodiments of the disclosure described above may be stored in a non-transitory computer-readable medium. The computer instructions stored in the non-transitory computer-readable medium cause the specific device described above to perform the processing operations in the electronic apparatus 100 according to the various example embodiments described above when executed by a processor of the specific device.

The non-transitory computer-readable medium may refer, for example, to a machine readable medium that semi-permanently stores the data. For example, the non-transitory computer-readable medium may, for example, and without limitation, be a CD, a DVD, a hard disc, a Blu-ray disc, a USB, a memory card, a ROM, or the like.

Although various example embodiments of the disclosure have been illustrated and described, it should be understood that the disclosure is not limited to the disclosed embodiments and may be variously changed without departing from the spirit and the scope of the disclosure. Therefore, the disclosure should be understood as including all the changes, equivalents, and substitutions included in the spirit and scope of the disclosure.

What is claimed is:

1. An electronic apparatus comprising:
a display;
a storage storing a content and metadata for the content therein; and
a processor configured to control the display to display information indicating a degree to which an artificial intelligence model contributes to a generation of the content based on the metadata.

2. The electronic apparatus as claimed in claim 1, wherein the metadata includes information on at least one of: a name of the artificial intelligence model used to generate the content, a learning object used in learning of the artificial intelligence model, the degree to which the artificial intelligence model contributes to the generation of the content, or work content that the artificial intelligence model performs to generate the content.

3. The electronic apparatus as claimed in claim 2, wherein the processor is configured to control the display to display information indicating the degree to which each artificial intelligence model contributes to the generation of the content based on the metadata based on a plurality of artificial intelligence models being used to generate the content.

4. The electronic apparatus as claimed in claim 3, wherein the processor is configured to obtain the degree to which each of the plurality of artificial intelligence models contribute to the generation of the content based on at least one of: a work time and an amount of work of each of the plurality of artificial intelligence models for generating the content, and to update the metadata based on the obtained degree of contribution.

5. The electronic apparatus as claimed in claim 2, wherein the processor is configured to control the display to display information on a learning object used in learning of the artificial intelligence model based on the metadata.

6. The electronic apparatus as claimed in claim 5, wherein the processor is configured to control the display to display information on the learning objects having different characteristics based on the metadata based on learning objects having different characteristics being used in the learning of the artificial intelligence model.

7. The electronic apparatus as claimed in claim 6, wherein the processor is configured to control the display to display the information on the learning objects having different characteristics and information indicating the degree of contribution in a hierarchy structure.

8. The electronic apparatus as claimed in claim 2, wherein the processor is configure to control the display to display the information on the work content that the artificial intelligence model performs to generate the content based on the metadata based on a plurality of works being required to generate the content.

9. A method for providing content information, the method comprising:
obtaining a degree to which an artificial intelligence model contributes to generation of the content based on metadata stored in a storage; and
displaying, on a display, information indicating the degree to which the artificial intelligence model contributes to the generation of the content.

10. The method as claimed in claim 9, wherein the metadata includes information on at least one of: a name of the artificial intelligence model used to generate the content, a learning object used in learning of the artificial intelligence model, the degree to which the artificial intelligence model contributes to the generation of the content, or work content that the artificial intelligence model performs to generate the content.

11. The method as claimed in claim 10, wherein in the displaying of the information, information indicating the degree to which each artificial intelligence model contributes to the generation of the content is displayed on the display based on the metadata based on a plurality of artificial intelligence models being used to generate the content.

12. The method as claimed in claim 11, further comprising:
obtaining the degree to which each of the plurality of artificial intelligence models contribute to the generation of the content based on at least one of a work time and an amount of work of each of the plurality of artificial intelligence models for generating the content; and
updating the metadata based on the obtained degree of contribution.

13. The method as claimed in claim 10, wherein in the displaying of the information, information on a learning object used in learning of the artificial intelligence model is displayed on the display based on the metadata.

14. The method as claimed in claim 13, wherein in the displaying of the information, information on the learning objects having different characteristics is displayed on the display based on the metadata based on learning objects having different characteristics being used in the learning of the artificial intelligence model.

15. The method as claimed in claim 14, wherein in the displaying of the information, the information on the learning objects having different characteristics and information indicating the degree of contribution are displayed on the display in a hierarchy structure.

16. The method as claimed in claim 10, wherein in the displaying of the information, the information on the work content that the artificial intelligence model performs to generate the content is displayed on the display based on the metadata based on a plurality of works being required to generate the content.

17. A system for providing content information, the system comprising:
an electronic apparatus configured to generate metadata for the content based on each of one or more artificial intelligence models works to generate the content, and to transmit the metadata; and
a terminal apparatus configured to display, on a display, information indicating a degree to which one or more artificial intelligence models contribute to generation of the content based on the metadata transmitted from the electronic apparatus.
